(19) United States
(12) Patent Application Publication
(10) Pub. No.: US 2016/0355376 A1
(43) Pub. Date: Dec. 8, 2016

(54) PRESENCE DETECTION OF AN OBJECT IN AN ELEVATOR

(71) Applicant: INVENTIO AG, Hergiswil (CH)

(72) Inventors: Astrid Sonnenmoser, Hochdorf (CH); Martin Kusserow, Luzern (CH); Reto Tschuppert, Luzern (CH)

(21) Appl. No.: 15/036,503

(22) PCT Filed: Nov. 11, 2014
(86) PCT No.: PCT/EP2014/074265

§ 371 Date: May 13, 2016

(30) Foreign Application Priority Data
Nov. 15, 2013 (EP) 13193001.8

(51) Int. Cl. B66B 5/00; G01J 5/00

(52) U.S. Cl. CPC B66B 5/0012; G01J 5/0022

(57) ABSTRACT

A method and a device for detecting the presence of an object in an elevator car of an elevator system that has a control unit include a color temperature sensor. The color temperature sensor is integrated into the elevator car to acquire the color temperature of the light incident on the color temperature sensor during elevator operation, and an object present in the elevator car is detected by the control unit connected with the color temperature sensor by comparing the color temperature acquired during elevator operation with a previously acquired reference color temperature.

### FIELD

The invention relates to a method and a device for detecting the presence of an object in an elevator car of an elevator system that exhibits a control unit.

### BACKGROUND

An elevator system in a building exhibits an elevator car, which is vertically moved between the floors of the building. To this end, the elevator car is joined with an elevator gear unit via suspension means.

JP 2003-040541 describes an arrangement for preventing passengers from remaining trapped in an elevator car. The arrangement encompasses a video monitoring camera and an image processor. The image processor compares the average brightness of the image pixels detected by the monitoring camera with the average brightness of the pixels in reference images of the empty elevator car, wherein these reference images were recorded under varying lighting conditions.

European Patent Application EP 0 832 839 A1 describes an identification system for an elevator system. An elevator user carries an information transmitter, wherein this information transmitter sends individual data, such as the weight and body mass of the elevator user, along with a desired floor destination to a detector inside of the elevator. The described information transmitter uses electromagnetic waves for transferring information. In addition, a separate unit determines the current weight of the elevator.

U.S. Pat. No. 5,555,512 discloses an image processing apparatus for processing infrared images, which were measured with an infrared sensor. The infrared image shows the distribution of heat within a specific range. The image processing apparatus further exhibits an image processing unit for extracting personal data as well as environmental characteristics based on the infrared images. Determined for this purpose are representative points of an area denoting the person within the infrared image, an area denoting a number of persons and a number of image points within the areas. Additionally ascertained are the average temperatures of the areas and the positions assumed by the extremities of the persons.

A motion detector can also be used to determine whether a person is present in an elevator car. A motion detector is an electronic sensor that recognizes movements in its immediate environment, and can thereby act as an electric switch. It can here operate either actively with electromagnetic waves (Doppler radar), ultrasound (ultrasonic motion detector), or passively based on the infrared radiation of the environment; there are also combinations thereof.

### SUMMARY

An object of the invention is to propose a simpler, more efficient and less expensive method for detecting the presence of an object in an elevator car of an elevator system.

The core of the invention lies in the fact that the color temperature of the light incident on the color temperature sensor is acquired in an elevator car of an elevator system during elevator operation by a color temperature sensor integrated into the elevator car, and that an object present in the elevator car is detected by a control unit connected with the color temperature sensor by comparing the color temperature acquired during elevator operation with a previously acquired reference color temperature.

The color temperature is a gauge that enables the quantitative determination of the color impression of a light source. The color temperature is defined as the temperature of a black body, of the so-called Planckian radiator, which belongs to a specific color of the light emanating from the black body. Specifically, it is the temperature at which the effect of light from the black body is most similar to the color to be described given an identical brightness and fixed observation conditions. Due to the correlation with the temperature of a black body, the abbreviation CCT (correlated color temperature) is used for the color temperature. Kelvin (K) is the color temperature unit.

The term “color temperature sensor” is to be understood as a signal-emitting optical device for selectively acquiring and evaluating the visible spectral range of light, wherein this spectral range encompasses wavelengths of about 380 nm to 780 nm. Typical designations for a color temperature sensor include LAB-color temperature sensor, True-Color-Sensor (true-color-sensor) or RGB-Sensor (red-green-blue sensor). The color temperature sensor separately acquires the colors red, green and blue (RGB). The color temperature sensor can calculate the correlated color temperature (CCT) for each measured RGB value, i.e., from the respective percentages of red, green and blue in the acquired light.

Any object desired can be detected in the elevator car. For example, it could involve a person, a material item, an animal, etc. An object is also regarded as an altered color scheme (e.g., a non-material item) of the elevator car space, which can be caused by adhesive bonding, spraying or some other damage to the interior space. A non-material item can also be regarded as smoke, fire or the like.

One advantage to the invention is that even those objects that emit little or no thermal radiation can also be detected in the elevator car.

Viewed as another advantage is that an object in the elevator car is detected by comparing a currently acquired color temperature to a reference color temperature, i.e., a static or fixed reference value determined beforehand for the color temperature, which places relatively minor requirements on the processor of the control unit that performs the comparison.

Another advantage is that the time for which the elevator car is empty can be estimated based on the comparison with the reference color temperature (reference value), which can be applied in usage load analyses for the elevator operator.

Another advantage is that the status of lamps inside the elevator car can be monitored in addition to detecting the presence of an object in the elevator cabin. For example, if lamps have failed, the control unit could send a message to a maintenance center of an elevator manufacturer to have the failed lamps replaced.

Viewed as another advantage is that the method according to the invention protects the privacy of a person in the elevator car, since only the color temperature (CCT) of the light incident on the color temperature sensor is acquired. The present invention cannot be used for acquiring the features of persons, e.g., as can be done when using a video camera for presence detection.

During elevator operation, the color temperature (CCT) is preferably acquired during a previously defined time period in previously defined time gaps (intervals). The elevator car exhibits at least one car door, which forms an elevator door in conjunction with one of the floor doors. For example, the previously defined time period can start after the elevator doors have opened or closed, or after the elevator car has begun moving.

Depending on how the method is designed, both the color temperature acquired during elevator operation and the previously acquired reference color temperature can be acquired in the elevator car either only with the elevator doors closed or with the elevator doors closed and open.

The control unit preferably generates a time-dependent color temperature curve based on the color temperature (CCT) acquired during a defined time period. Referred to here as a color temperature curve is a curve generated by the control unit, which is defined by a number n of color temperature values that were acquired and recorded during a time t. The color temperature values and color temperature curves generated therefrom can be stored in a memory unit of a control unit.

Before elevator operation begins, a previously acquired reference color temperature is preferably acquired with the elevator car empty, and recorded as a time-dependent reference color temperature curve.

The comparison performed by the control unit between the color temperature curve acquired during elevator operation and the reference color temperature curve preferably takes place as a function of at least one rule.

A stochastic evaluation method is preferably used for comparing the color temperature curves.

For example, the stochastic evaluation method used can involve the determination of a normal distribution, the determination of a Gaussian distribution, the ascertainment of a variance, the determination of an average value and/or a maximum value. A normal distribution or Gaussian distribution of the acquired color temperature values could be acquired and used as the basis of comparison, for example. However, characteristic values such as a variance, an average value or a maximum value could also be drawn upon for the comparison. The normal distribution is a parametric distribution described by the average value and variance, i.e., when using the normal distribution, the average value and variance can be derived therefrom. Of course, it is also conceivable according to the invention to also use non-parametric evaluation methods or mathematical procedures, for example classification by k-nearest neighbor (k-nearest neighbor). In such evaluation methods or procedures, characteristic values such as the median, minimum, maximum or the like are determined and used.

Depending on the comparison between color temperature curves acquired during elevator operation and the reference color temperature curve, which was preferably performed using stochastic methods, and depending on at least one rule, the control unit determines whether an object is present in the elevator car. In the simplest case, the at least one rule involves the fact that the at least one comparison value previously determined via stochastic methods for the color temperature curves acquired during elevator operation must be greater or less than the comparison value determined via stochastic methods for the reference color temperature curve, so that it can be assumed that an object is located in the elevator car. Of course, the at least one rule can be configured as desired, and depends among other things on the used evaluation method or on the used mathematical process. For example, the vertical position of the elevator car in an elevator shaft or the floor approached by the elevator car could also be used for the at least one rule, since the lighting conditions on the individual floors might vary.

In one of the possible embodiments of the method according to the invention or the arrangement according to the invention, the elevator car goes through at least one test run to acquire the reference color temperature. This makes sense in particular when objects present in the elevator car are also to be detectable with the elevator doors open. With the elevator car empty, the previously acquired reference color temperature is for this purpose acquired once with the elevator doors closed, and also with the elevator doors open on each floor. A test run can basically be understood to mean that the elevator car moves vertically to each floor of the building in which the elevator system is located, wherein the elevator doors are opened and then closed again on the respective floor. During the test run, the color temperature sensor acquires a reference color temperature assigned to the floor on each floor, preferably in the form of a time-dependent reference color temperature curve. However, the reference color temperature is exclusively determined with the elevator doors closed for most applications of the invention.

Preferably used as the control unit for evaluating the signals of the color temperature sensor are an elevator controller, a control unit of the color temperature sensor and/or a separate control unit. This yields a high flexibility of use for the invention.

The control unit is preferably connected with the color temperature sensor by a wireless communication network. In this way, the invention can be realized without having to incorporate additional signal lines between the control unit and the elevator car or color temperature sensor.

### DESCRIPTION OF THE DRAWINGS

The invention will be explained in greater detail below based on an exemplary embodiment shown on the figures. Shown here on:

FIG. 1 is a simplified illustration of an elevator system according to the invention;

FIG. 2 is a diagram showing how the presence of an object triggers changes of varying strength in an illuminance curve and a color temperature curve; and

FIG. 3 is a simplified illustration of an elevator car with an object to be detected.

### DETAILED DESCRIPTION

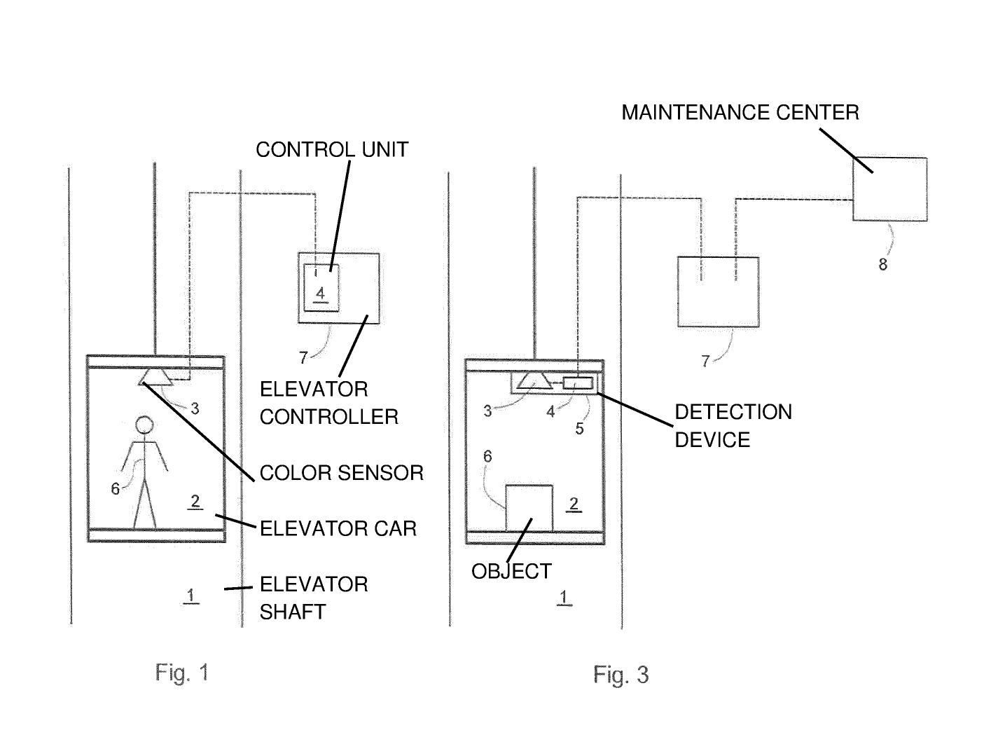

FIG. 1 presents a schematic illustration of an elevator designed for using the method according to the invention. An elevator car 2 moves vertically up and down in an elevator shaft 1 between the floors of a building (not shown). The elevator car exhibits a cabin door, which in conjunction with a respective floor door comprises an elevator door. The elevator car 2 is here connected with a drive (not shown) via a suspension means, specifically a rope, a belt or something similar. The elevator system further exhibits a control unit 4, which in the present example can be designed as part of an elevator controller 7.

The elevator car 2 incorporates a color sensor 3 in such a way that it can monitor the interior space of the elevator car 2. Several color temperature sensors 3 can also be situated at various locations or positions in the elevator car 2. In the example according to FIG. 1, the color temperature sensor 3 is installed or arranged on the ceiling of the elevator car 2.

The color temperature sensor 3 is connected with the control unit 4 by means of a hard-wired or wireless communication network. According to the invention, the control unit 4 could also be configured as a unit of the color temperature sensor 3 or as a separate unit. For example, the control unit 4 could be designed in such a way as to receive parameters or data transmitted by sensors, such as the color temperature sensor 3, of the elevator system, for example, process the latter and send the results to a maintenance center of an elevator manufacturer.

The color temperature sensor 3 in the elevator car 2 acquires at least the visible light in a spectral range of between about 380 nm and 780 nm, which is incident on the color temperature sensor 3. Generally understood as a color temperature sensor 3 is a signal-emitting optical device for selectively acquiring and evaluating the visible spectral range of light, i.e., a device that separately acquires the colors red, green and blue (RGB), and calculates the color temperature (CCT) of the light incident on the device from the percentages of acquired basic colors.

The color temperature (CCT) can be acquired by the color temperature sensor 3 with the elevator door open and/or closed. However, the presence of an object 6 in the elevator car 2 is preferably detected only with the elevator door closed. The object 6 can be a person, an animal, a material item or the like. The object 6 could also involve an altered shape or non-material item of the elevator car space, for example which can be caused by adhesive bonding, spraying with paint or some other damage to the interior space. In the present example, an object 6 in the form of a person is to be detected.

With the elevator in operation, the color temperature (CCT) is ideally acquired during a previously defined time t with a previously defined time gap (interval) between individual measurements. The control unit 4 uses the measured values to generate a so-called color temperature curve “B”, which is defined by a number n of color temperature values that were determined and recorded over time t. The color temperature curve can be evaluated with the help of stochastic or statistical evaluation methods, as well as with specific mathematical processes. The control unit 4 uses such evaluation methods to compare color temperature curves acquired or generated during elevator operation with the previously acquired reference color temperature curve, and the object 6, here a person, in the elevator car 2 is detected as a function of this comparison.

The reference color temperature curve acquired previously with the elevator car 2 empty can here be stored in a memory unit of the control unit 4. In particular if the method according to the invention is also to detect objects with the elevator car door open, a test run of the elevator car 2 can be performed to acquire the reference color temperature curve. A test run can basically be understood to mean that the elevator car 2 is moved vertically to each floor of the building in which the elevator system is located, and that the elevator door is opened and then closed again on the respective floor. During the test run, the color temperature sensor 3 acquires color temperatures allocated to the floors and car door status, which can be used for determining floor-related reference color temperature curves.

The color temperature curve acquired during elevator operation can be compared to the reference color temperature curve acquired previously with the elevator car 2 empty using various stochastic or statistical evaluation methods and/or mathematical processes. For example, a normal distribution or Gaussian distribution could be determined. A variance, an average value and/or a maximum value could also be drawn upon for comparison purposes.

The measured values of the color temperature sensor 3 acquired during elevator operation can be analyzed by evaluating the color temperature curve generated therefrom using the aforementioned evaluation methods or mathematical processes. The control unit 4 can detect features from the latter, which are then compared with analogous features of the previously acquired reference color temperature curve. For example, such features can be a maximum value, a variance, an average value, a standard deviation, a deviation to a specific measured value or parameter, specific measured values at a time t or the like.

The control unit 4 can detect an object 6 as a function of a comparison between the two color temperature curves and at least one rule. In the simplest case, the one rule involves the fact that the feature ascertained by evaluating the color temperature curve during elevator operation must be greater or less than the feature determined by evaluating the reference color temperature curve, so that it can be assumed that an object 6 is located in the elevator car 2. Of course, the at least one rule can be configured as desired, and depends among other things on the used evaluation method or used mathematical process. For example, the vertical position of the elevator car 2 in the elevator shaft 1 or floor approached by the elevator car 2 could also be used as a rule, since the lighting conditions on the individual floors can vary.

If the control unit 4 detects an object 6, the elevator system can take a wide variety of actions. If the control unit 4 detects damage to the interior space of the elevator car 2, for example during a test run, the control unit 4 can transmit information about the damage to a maintenance center of an elevator manufacturer. This can be done with a message sent over a hard-wired or wireless communication network. If the control unit 4 identifies the object 6 as a material item, for example a crate, a box or the like, e.g., by additionally comparing the current color temperature curve with a master color temperature curve, the elevator door can be left open or opened. If a person is detected in the same manner, an elevator ride can be initiated or the elevator door can be opened as a function of an input ride query, provided no ride destination was entered.

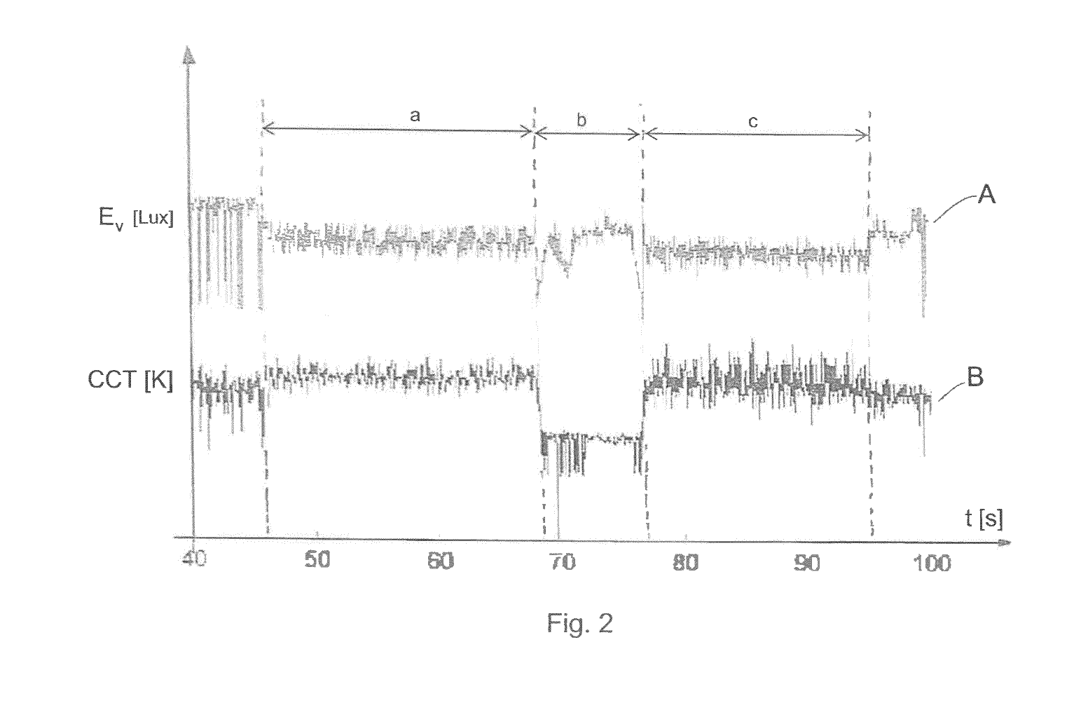

FIG. 2 shows two time-dependent measurement curves for the measured values of light variables acquired in an elevator car with different light sensors. The measured values are here acquired in the visible wavelength range of light. Measured values for illuminance Eᵥ (measured in Lux) were recorded as a function of time t as illuminance curve A for measurement curve “A”, while measured values for CCT (measured in Kelvin (K)) were recorded as a color temperature curve for measurement curve “B”.

The two measurement curves A and B are divided into three segments a, b and c in this example. Segment c describes time periods of both measurement curves, in which an object—e.g., a person—is present in the elevator car 2, and the elevator door is closed. Segment b shows time periods of both measurement curves in which the elevator door is open. Segment a shows time periods of both measurement curves in which the elevator car 2 is empty, and the elevator door is closed. In both illuminance curve A and color temperature curve B, the variance of measured values increases in segment c (object present). However, the detectable and evaluable difference—e.g., the difference in variance for the measured value series—between the time period with object present and time period with object not present is significantly greater for the color temperature curve CCT, which reveals the enormous advantage offered by presence detection with a color temperature sensor.

FIG. 3 presents a schematic illustration of another elevator system configured for using the method according to the invention. The elevator system encompasses an elevator car 2, which exhibits a device 5 according to the invention for presence detection. Present in the elevator car is an object 6 to be detected, for example a material item, such as a box. The elevator system further encompasses an elevator controller 7. The method for detecting the object 6 is performed as described above in conjunction with FIGS. 1 and 2.

In the example shown, the control unit 4 and color temperature sensor 3 comprise an arrangement 5 for presence detection as an integrated unit. However, the control unit 4 can also be present as a separate unit, and connected with the color temperature sensor 3 via a communication network. The control unit 4 is also connected with the elevator controller 7 as well as with a maintenance center 8 of an elevator manufacturer by means of a hard-wired or wireless communication network. It can transmit to this maintenance center 8 features of the color temperature curve detected in a message or information already derived from the color temperature curve relating to the presence of an object 6 or a change in status inside the elevator car 2. In this way, for example, damage to the interior space of the elevator car 2 that influences the color temperature can be displayed in order to have a service technician service the elevator system. The method according to the invention can also be used to detect a defective lamp of the car lighting system, and request a replacement. Information as to whether an object 6 is located inside the elevator car 2 is not only relevant for controlling the elevator system, but also in cases where the elevator system is not working, and a person is trapped inside the elevator car 2. Such information can also be important given a fire in the building, so that efficient and fast measures can be taken to rescue the person trapped inside the elevator car 2.

In accordance with the provisions of the patent statutes, the present invention has been described in what is considered to represent its preferred embodiment. However, it should be noted that the invention can be practiced otherwise than as specifically illustrated and described without departing from its spirit or scope.

1-11. (canceled)

12. A method for detecting a presence of an object in an elevator car of an elevator system comprising the steps of:
acquiring, using a color temperature sensor integrated into the elevator car, a color temperature of light incident on the color temperature sensor during elevator operation; and
detecting an object present in the elevator car using a control unit connected with the color temperature sensor by comparing the color temperature acquired during the elevator operation with a previously acquired reference color temperature and generating information associated with detecting the object.

13. The method according to claim 12 wherein the previously acquired reference color temperature is acquired during a previously defined time period in previously defined time gaps during the elevator operation.

14. The method according to claim 12 wherein the control unit generates a time-dependent color temperature curve based on the color temperature acquired during the elevator operation.

15. The method according to claim 14 wherein the previously acquired reference color temperature is acquired with the elevator car empty, and is recorded as a time-dependent reference color temperature curve.

16. The method according to claim 15 wherein the comparison performed by the control unit between the time-dependent color temperature curve acquired during the elevator operation and the time-dependent reference color temperature curve is based upon at least one rule.

17. The method according to claim 12 including using a stochastic evaluation method for comparing the color temperature acquired during the elevator operation with the previously acquired reference color temperature.

18. The method according to claim 17 wherein the stochastic evaluation method involves determination of a normal distribution, determination of a Gaussian distribution, ascertainment of a variance, determination of an average value and/or a maximum value.

19. The method according to claim 12 wherein the elevator car goes through at least one test run to acquire the previously acquired reference color temperature.

20. The method according to claim 12 wherein the control unit is at least one of an elevator controller, a control unit of the color temperature sensor and a separate control unit.

21. The method according to claim 12 wherein the control unit is connected with the color temperature sensor by a wireless communication network.

22. A device for detecting a presence of an object in an elevator car of an elevator system comprising:
a color temperature sensor integrated into the elevator car for acquiring a color temperature; and
a control unit connected with the color temperature sensor, wherein the control unit detects an object present in the elevator car by comparing a color temperature acquired during elevator operation with a previously acquired reference color temperature and generates information associated with the detected object.

23. The device according to claim 22 wherein the control unit is at least one of an elevator controller, a control unit of the color temperature sensor and a separate control unit.

24. The device according to claim 22 wherein the control unit transmits the information to at least one of an elevator controller and a maintenance center.
